(19) United States
(12) Patent Application Publication
(10) Pub. No.: US 2008/0102962 A1
(43) Pub. Date: May 1, 2008

(54) Video game extremity control and object interaction

(76) Inventors: Scott M. Pease, Tarzana, CA (US); Benjamin Matthew Kutcher, Semi Valley, CA (US); Cody P. Pierson, Hollywood, CA (US); Brian K. Bright, Los Angeles, CA (US); Zachary M. Drake, Woodland Hills, CA (US)

Correspondence Address: CHRISTIE, PARKER & HALE, LLP, PO BOX 7068, PASADENA, CA, 91109-7068, US

(21) Appl. No.: 11/588,850

(22) Filed: Oct. 27, 2006

(51) Int. Cl. A63F 13/10

(52) U.S. Cl. 463/43; 463/1

(57) ABSTRACT

A video game with multi-axis multi-extremity control. In some embodiments separate extremity control is provided for two legs of a simulated character and movement of the legs affects motion of an inanimate object, for example a skateboard. In some embodiments multi-access multi-extremity control is provided only during a portion of video game play, and the portion may be experienced in slow motion.

### BACKGROUND OF THE INVENTION

The present invention relates generally to multi-axis extremity control in a video game, and more particularly to multi-axis extremity control and inanimate object interaction.

Video games are commonly used by many, generally providing a source of entertainment and at times a learning experience for a video game user. Video games often allow users to engage in an interactive visual experience, with the user generally operating controls to perform simulated actions, operate simulated items, and/or otherwise interact with a simulated environment. The simulated environment may be based on reality or entirely fanciful, with users controlling simulated characters taking on roles and performing actions that range from having some correspondence with every day reality to being completely divorced from the present world.

Many video games provide a user with some aspects of control of the movement of a simulated character. For example, performing a sequence of control operations, such as pressing a sequence of buttons on a game controller, may result in a simulated character executing a predefined sequence of maneuvers. Unfortunately, the predefined sequence of maneuvers may relate to various predefined maneuvers that encompass all of the simulated character's body, and thus a granularity of control of the simulated character is not provided to the user.

However, excessive detailed control of the simulated character may be undesirable in the context of a video game. For example, having to control in detail a simulated character's motions may be difficult, and users may be unable to accomplish control sufficient to allow game play. Moreover, requiring a detailed level of control may be wearying, and detract from overall game enjoyment.

### BRIEF SUMMARY OF THE INVENTION

The invention provides multi-axis extremity control for a video game. In one aspect the invention provides a method of extremity control in a video game, comprising determining a position of an extremity of a simulated character using input information provided from a game controller, the input information representative of position in at least two axes; and determining display related information for the extremity.

In another aspect the invention provides a video game system including an extremity control feature, comprising a memory storing executable video game code including executable code providing at least partial control of a representation of an individual interacting with a representation of an inanimate object in a simulated setting, the partial control including independent simulated movement of each of two extremities in at least two axes of motion, with movement of each extremity in at least one axis of motion resulting in modification of simulated motion of the representation of the inanimate object; and a processor in data communication with the memory, the processor configured to execute the executable video game code, to receive signals indicative of commands for simulated movement of each of the two extremities, to modify data representative of the position of each of the two extremities, and to modify data representative of simulated motion of the representation of the inanimate object.

In another aspect the invention provides a method of providing trick operations in a skate boarding video game, comprising modifying a simulated rate of passage of time in response to a valid request to enter a trick mode, simulating movement of a simulated extremity along a first axis in response to a request to move the simulated extremity along the first axis, and simulating three dimensional movement of a simulated skateboard in accordance with the simulated movement of the simulated extremity.

These and other aspects of the invention are more fully comprehended upon study of this disclosure.

### BRIEF DESCRIPTION OF THE DRAWINGS

FIG. 1 is a flow diagram of a process including an embodiment of extremity control in accordance with aspects of the invention;

FIG. 2 is a block diagram of an embodiment of a system in accordance with aspects of the invention;

FIG. 3 illustrates an example of two dimensional movement of two extremities;

FIG. 4 is a flow diagram of a further process including an embodiment of extremity control in accordance with aspects of the invention;

FIG. 5 illustrates controller movement in accordance with aspects of the invention;

FIGS. 6A-6E illustrate multi-axis extremity control and object interaction using an example of a skateboarder and skateboard;

FIG. 7 is a module diagram including extremity control in accordance with aspects of the invention;

FIG. 8 is a flow diagram of a mode process in accordance with aspects of the invention;

FIG. 9 is a flow diagram of an extremity control process in accordance with aspects of the invention;

FIG. 10 is a flow diagram of a further extremity control process in accordance with aspects of the invention;

FIG. 11 is a flow diagram of a further extremity control process in accordance with aspects of the invention;

FIG. 12 is a flow diagram of a process for determining position of an inanimate object;

FIG. 13 is a flow diagram of an object position process in accordance with aspects of the invention; and

FIG. 14 is a flow diagram of a points process in accordance with aspects of the invention.

### DETAILED DESCRIPTION

In some embodiments the invention provides program instructions for a video game in which determined position of at least one extremity of a video game character is responsive in at least two dimensions to inputs received from at least one input device operated by a user. Preferably a multi-axis analog control (or a multi-bit digital control), providing inputs for each of at least two dimensions of motion, is used as an input device.

For example, in some embodiments leg or foot position of the character, who in a particular embodiment may be a skateboarder using a skateboard, is responsive in a forward (and/or backward) direction and at least one side direction, relative to the skateboarder. A user can thus control the leg or foot position of the character by manipulating the multi-axis analog control such that movements of the multi-axis analog control cause corresponding movements in the leg or foot position of the character. Preferably position of each leg is independently controlled by a separate multi-axis control.

In some embodiments motion of an inanimate object, such as the skateboard, is affected by motion of the extremities. Thus, as the user manipulates the multi-axis analog control to cause corresponding movements in the leg or foot position of the character, the skateboard moves in response to the leg or foot movements. This enables a user to have more control over specific movements of the character's extremities and to cause the skateboard to respond to leg or foot movements as it would respond in reality or an idealized reality. For example, some actual skateboarders are able to use foot and leg movements to flip their skateboards about various axis while both skateboarder and skateboard are in the air. In some embodiments of the invention, the user uses a multi-axis control to control a skateboarder character's leg, preferably with a direct correspondence between multi-axis control directions and leg directions so that the control and the leg movements are in the same direction, to simulate the same movements so that the skateboard flips about the various axis.

Further, in some embodiments the video game includes a first mode in which game play is provided without direct multi-axis extremity control, and a second mode in which game play is provided with direct multi-axis extremity control. The second mode may entered from the first mode, in some embodiments if certain conditions are met, and the second mode may also include a slow motion feature, for example, in which, passage of simulated time in the second mode occurs at a slower rate than in normal game play. Thus, for example, a skateboarding video game may include a normal game play mode and a second mode, enterable under certain conditions, such as the skateboard being airborne, upon receipt of a user input device request. With the skateboard in the air, a user using an input device may command motion of the skateboarder's legs, causing the airborne skateboard to rotate in various directions.

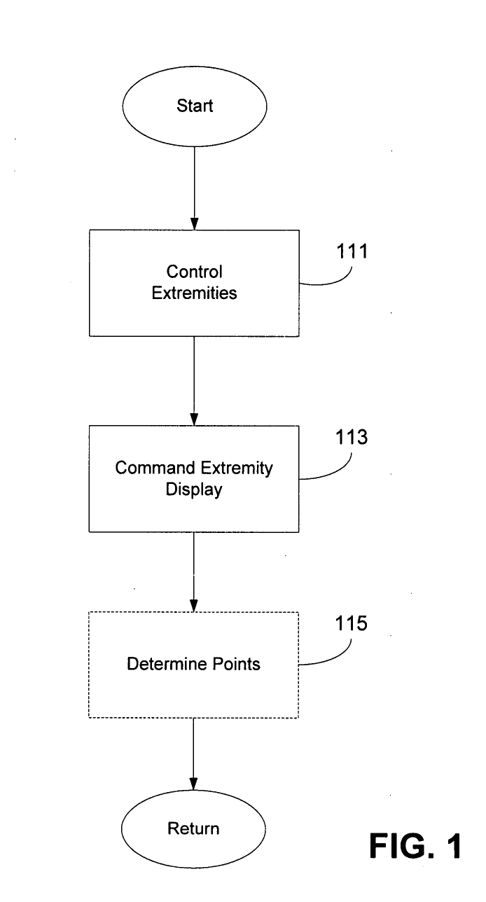

Turning now to the figures, FIG. 1 is a flow diagram of a process of extremity control in a video game. In block 111 the process determines positions of at least one extremity, and preferably a plurality of extremities, of a character in a video game. The positions of the extremities are determined, at least in part, using input information provided, for example, from a game controller. In many embodiments the input information is representative of movement or position in at least two axes for each extremity being controlled at a particular time, although in some embodiments the input information is representative of movement or position in only a single axis for each extremity being controlled. In some embodiments the process receives separate inputs for each axis of motion for each extremity. In other embodiments the process receives an encoded single input representative of movement or position in at least two axes for each extremity.

In block 113 the process determines display related information for each extremity. In some embodiments determining display related information for each extremity comprises determining positions of extremities in a simulated three-dimensional space, with display parameters determined based on a view point within the three-dimensional space. In other embodiments determining display related information for each extremity comprises determining movement or positioning of the extremities from a predefined view relative to the character.

In block 115 the process optionally determines point values associated with extremity position or movement. Thus, in some embodiments of a video game, points are provided for various movements, and the process determines points, which may be added to a cumulative point score, in response to movement or changes in position of the extremities, or possibly merely movement or change in position of the controller.

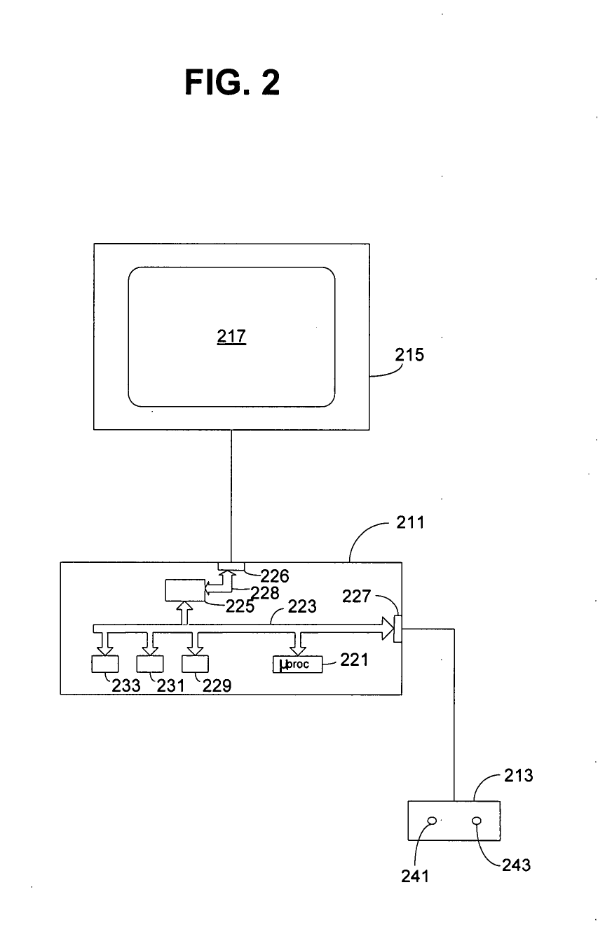

FIG. 2 is a block diagram of a system in accordance with aspects of the invention. The system includes a processing unit 211. The processing unit is in data communication with a game controller 213 and a display unit 215. A display 217 is provided by the display unit. At times the display unit 215 and the display 217 may both be commonly referred to as a “display”, with the meaning understood from the context of use. The game controller provides inputs to the processing unit, and the display displays video game action based on signals provided to the display unit by the processing unit. In some embodiments the processing unit is a personal computer, in other embodiments the processing unit is a game unit including a processor and related circuitry, for example a PS2® by Sony Corporation, an Xbox® by Microsoft Corporation, or in some embodiments portions of an arcade game unit. PS2® is a registered trademark of Sony Corporation. Xbox® is a registered trademark of Microsoft Corporation. The display unit is generally a television, but in various embodiments may take the form of various different display terminals, and in some embodiments may be a display associated with an arcade game unit. The game controller may be a computer input device having a somewhat general applicability, such as a keyboard or mouse, but in most embodiments comprises a game controller adapted for use with game units, and in some embodiments comprises controls of an arcade game unit. Moreover, in some embodiments the system of FIG. 2 is implemented in a unitary fashion, such as a handheld game player.

The processing unit 211 includes a microprocessor 221. The microprocessor, as illustrated, is coupled to a bus 223 which interconnects the microprocessor with a display driver 225 and an input/output (I/O) port 227 (which in some embodiments is only an input port). In various embodiments the I/O port may be implemented using wireless circuitry. The display driver provides display information over a bus 228 to an output port 226. Information from the output port 226 is provided to the display unit 215 for display on the display 217. Although the bus coupling the video driver and the output port is shown as a bidirectional bus, in many instances the bus will be a single directional bus, and in some instances a serial data line.

Also coupled to the bus are a variety of other components commonly found on many devices including a processor. The other devices may be, for example, memory 229, external memory interface circuitry 231, such as for a CD-ROM, and other circuitry 233.

In operation the microprocessor commands retrieval of program instructions stored in the memory 229, executes the instructions, and provides data for storage in the memory and/or provides data to the display driver. In many embodiments the instructions are originally stored in the CD-ROM, or other such memory device, and transferred to the memory at the command of the microprocessor. The display driver, which in some embodiments is implemented as part of the microprocessor, generates display information for provision to the display by way of the output port.

The controller, as illustrated in FIG. 2, includes a first input device 241 and a second input device 243. For convenience, the first input device may be considered a bi-directional, bi-input device, and the second input device may also be considered a bi-directional, bi-input device. Further, in many embodiments, the devices may provide multi-bit values, or analog values. For example, in some embodiments each device may include a portion moveable in two axes or combinations thereof. For example, each device may comprise a ball or stick moveable in at least two axes. Associated with each axis may be a potentiometer, with a voltage across each potentiometer varying based on position of the ball or stick. Each potentiometer may provide an analog signal of varying voltage, which in some embodiments may be converted by an analog-to-digital converter (ADC) to a multi-bit value. Thus, for example, the first input device may provide for two axes of control of a character's left extremity, such as an arm or a leg. Similarly, the second input device may provide for two axes of control of a character's right extremity, such as another arm or leg. In other embodiments one, three or more input devices are used with the invention.

Signals from the input device 213, as illustrated in FIG. 2, are provided to the I/O port 227 of the processing unit, and the I/O port, which includes associated circuitry in most embodiments, provides the inputs to the microprocessor or memory, depending on implementation. The microprocessor, in accordance with program instructions read from the memory, accesses the data from the input device, whether by way of the I/O port or the memory, and stores in memory data representative of position of the controlled extremity. The microprocessor also provides simulated position information of the extremity to the video driver, either in the form of position information or, depending on the implementation, image data.

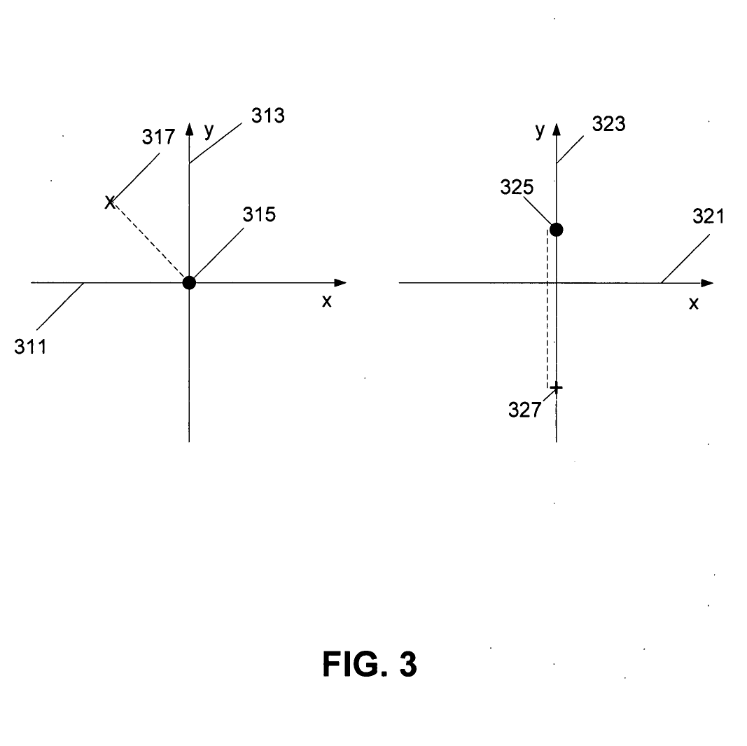

FIG. 3 illustrates an example of changes in position of two extremities in response to inputs provided by a controller such as described with respect to FIG. 2. For purposes of exposition the extremities may be considered a left foot and a right foot. It should be recognized, however, that position of a foot is dependent on position of the corresponding leg, and either the foot or the leg may be considered to be an extremity.

In FIG. 3 a left foot is at a first position 315 of a left extremity coordinate system, with the left extremity coordinate system defined by an x-axis 311 and a y-axis 313. As the first position is at the intersection of the x-axis and the y-axis, the first position may be considered as an origin of the left extremity coordinate system. A right foot is at a first position 325 of a right extremity coordinate system, with the right extremity coordinate system defined by an x-axis 321 and a y-axis 323, with the first position 325 being along the positive portion of the y-axis. As illustrated, the left x-axis and the right x-axis are co-linear and the left y-axis and the right y-axis are parallel. Thus, a single coordinate system may be used instead, and is used in many embodiments. In some embodiments positions in one coordinate system may be transformed to the other, or positions in both coordinate systems transformed to some other coordinate system.

In FIG. 3 the left foot is shown as moved to a second position 317. The second position may be considered as having a negative x position and a positive y position in the left coordinate system. Assuming a system such as described with respect to FIG. 2, the left foot may be commanded to be moved using a control, such the first input device of FIG. 2. In one embodiment the first input device includes a moveable stick and movement of the foot corresponds to the movement of the stick. Thus, movement of the stick from a first position, corresponding to the first position 315, to a second position, corresponding to the second position 317, results in corresponding movement of the foot from the first position 315 to the second position 317. Movement of such a stick may cause changes in values associated with potentiometers coupled to the stick, with the values indicating position of the stick. Thus, in embodiments where the x-axis corresponds to a first axis associated with a first potentiometer and the y-axis corresponds to a second axis associated with a second potentiometer, adjusting position of the stick of the first input device is accomplished in both the first axis and the second axis, and values associated with both the first potentiometer and the second potentiometer both change. A processor, for example the microprocessor of FIG. 2, receives data indicative of the values and modifies data representative of position of the left foot.

Similarly, the right foot is shown as moved to a second position 327. The second position 327 may be considered as having a position along the negative portion of the y-axis. Accomplishment of movement of the right foot is as described with respect to the left foot, using a control, such as the second input device of FIG. 2. Thus, in one embodiment, the first input device includes a moveable stick and movement of the foot corresponds to the movement of the stick. Thus, movement of the stick from a first position, corresponding to the first position 325, to a second position, corresponding to the second position 327, results in corresponding movement of the foot from the first position 325 to the second position 327. However, the adjustment of position of the moveable stick of the second input device, for this particular movement, is only along the y-axis, with the result that values provided by a potentiometer that vary with y-axis position change, while values provided by a potentiometer that vary with x-axis position do not change, at least to the degree of precision required by the processor.

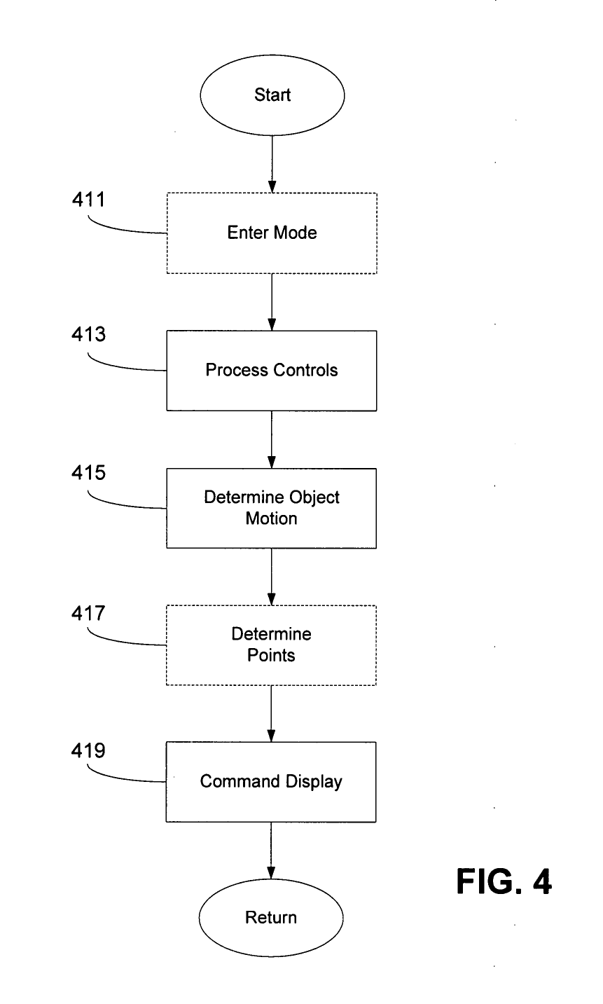

FIG. 4 is a flow diagram of a further embodiment of a process in accordance with the invention. The process may be performed, for example, by the system of FIG. 2. In optional block 411 the process enters a multi-extremity multi-axis control mode. In some embodiments, multi-extremity multi-axis control mode is entered in response to predefined inputs from an input device. For example, an input device may have two multi-axis controls that each include a depressible switch, and depressing both multi-axis controls commands entry into the mode. In some embodiments such could be done at any point in the game or, in some embodiments, only under specified circumstances, such as when a character such as a skateboarder is in the air.

Generally the multi-extremity multi-axis control mode differs from other game modes. In some embodiments multi-extremity multi-axis control mode may be characterized by a mapping of inputs from the game controller to functions, such as actions of a character, that are different from other modes. In some such embodiments, controls of the game controller, for example the multi-axis controls, are mapped to the positioning and movement of the extremities of the character, such that movement of inputs on the game controller correspond to movements of the extremities of the character. In some embodiments multi-extremity multi-axis control mode may be characterized by an elapse of simulated time of the video game that is different, slower in most embodiments, than other modes. In such embodiments, the elapse of time is slowed to provide for what is generally considered slow motion.

In block 413 the process processes control inputs. Generally speaking, the control inputs relate to multiple axis movement or positioning of an extremity or multiple extremities of a character, with inputs for each axis of movement or positioning. The process modifies data representative of position of the extremity or multiple extremities of the character in response to the inputs.

In block 415 the process determines motion of an object. In most embodiments the object is an inanimate object, whose motion is affected by motion or position of the character's extremities. In some embodiments the motion of the inanimate object is determined by motion of the extremities, whereby movement of a first extremity of the character in a first direction causes movement of the inanimate object in one direction, and movement of the first extremity of the character in a second direction causes movement of the inanimate object in another direction. Motion of the inanimate object may be the same for corresponding motions of the second extremity of the character, although generally directions of motion will differ for change in position of different extremities. In some embodiments, however, motion of the inanimate object is controlled by position of the character's extremity or extremities. In addition, velocity of motion may depend, in some embodiments, on a degree of closeness of commanded motion to a predefined axis.

In some embodiments motion of the inanimate object in the one direction and the other direction are translations; in others, motion of the inanimate object in the different directions is rotational. Furthermore, in some embodiments motion of the character's extremities is translational while motion of the inanimate object is rotational. In various embodiments velocity of movement of the inanimate object is dependent on whether the user manipulates the input device according to specified parameters. Examples of such parameters include commanded position of the extremity of the character, magnitude of position change of the extremity of the character, velocity of position change, or magnitude of commanded position change, or, in some embodiments, a combination of commanded position of the extremity and current position of the inanimate object.

In some embodiments motion of the inanimate object is affected by motion or position of the character's extremities only if the inanimate object has a position within a predefined range of positions relative to the character. For example, in a skateboard video game, changes in motion of an inanimate object such as a skateboard may be not allowed if the skateboard is not within a certain angle of being grip tape side up or trucks up relative to the skateboarder or the skateboarder's extremities.

In optional block 417, the process determines points associated with motion of the inanimate object and/or the extremities. In some embodiments the points are determined based on movement or position of the extremities or movement or position of the controls, in some embodiments the points are determined based on movement or position of the inanimate object and in some embodiments the points are determined based on the combination of movement or position of the extremities and movement and position of the inanimate object. In many embodiments points are determined such that additional points are determined for increasing velocity of motion of the inanimate object and for motion in multiple directions.

In block 419 the process commands a display to display a representation of the extremities and the object, preferably in motion. In some embodiments commanding of the display is merely writing of data to a data memory, which is read by a display generation device in order to generate a display scene. The process afterwards returns.

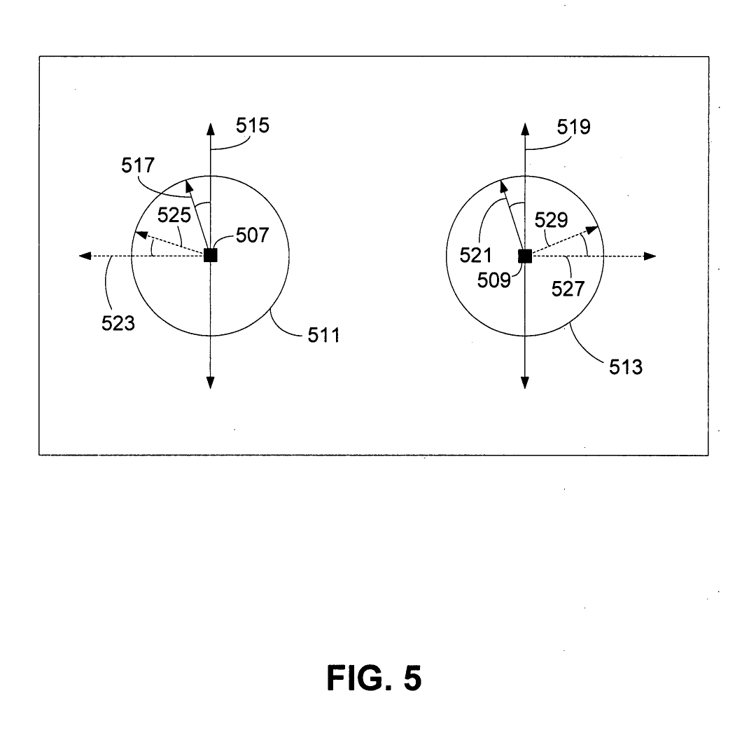

FIG. 5 is a diagram showing directions of axes for two multi-axis controls of a game controller useful in some embodiments of the invention. The multi-axis controls include a left control 511 and a right control 513. The controls may be implemented, for example, by using sticks 507, 509, which may be spring loaded posts moveable in at least two axes and movement along the axes resulting in adjustment of resistance of a potentiometer associated with the axis. For example, the left control includes a first axis 515 and a second axis 523. The spring loaded post is normally biased to a center position, and is moveable within a radial distance from the center position. Movement of the post in one direction having a component of movement along the first axis 515 increases a left first input value, movement of the post in the opposing direction decreases the left first input value. Movement of the post having a component along the second axis 523 increases (or decreases) a left second input value. Of course, movement of the post not directly on an axis, as shown by post movements 517, 525, normally changes both the left first input value and the left second input value, and calculations using these values may be used to determine an angle of post position. Thus, in some embodiments the left first input value and the left second input value are used, by a processor for example, to determine an angle of post position with respect to the center position.

Similarly, the right control includes a first axis 519 and a second axis 527. A spring loaded post is normally biased to a center position, and is moveable within a radial distance from the center position. Movement of the post results in changes to a right first input value and a right second input value, as discussed with respect to the left first input value and the left second input value for the left post. Again, as discussed with respect to the left control, movement of the post may be in a direction not directly on an axis, as shown by post movements 521, 529. While the embodiments herein discussed contemplate a spring loaded post, in other embodiments other components of an input device are used, such as buttons, a mouse, rolling balls, touch pads, or, in some embodiments, an actual skateboard device.

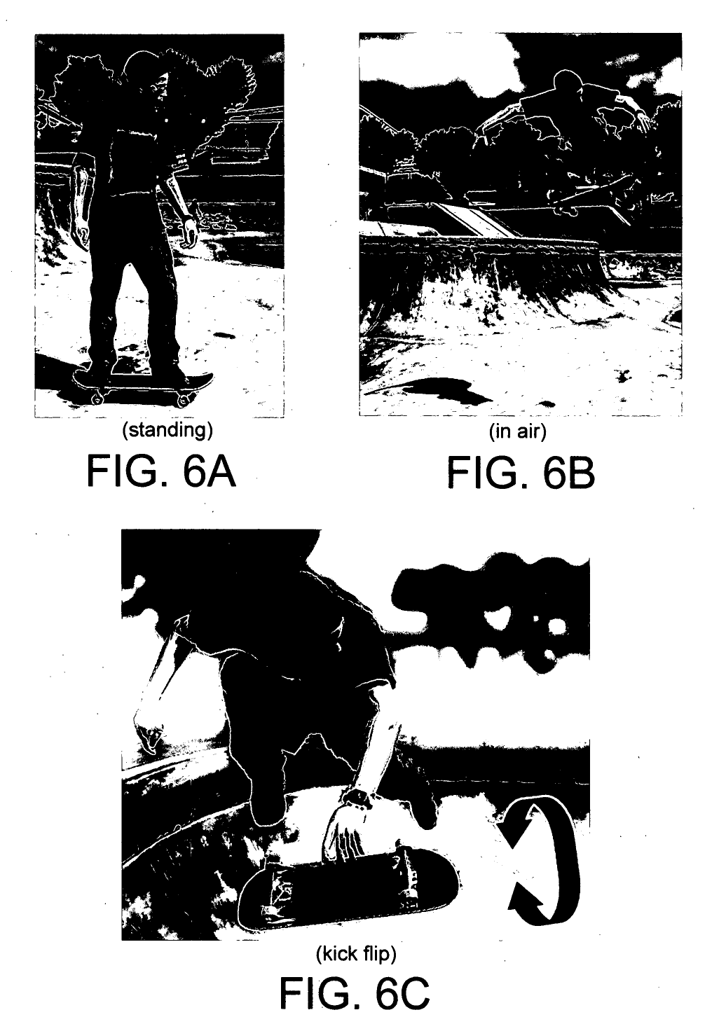

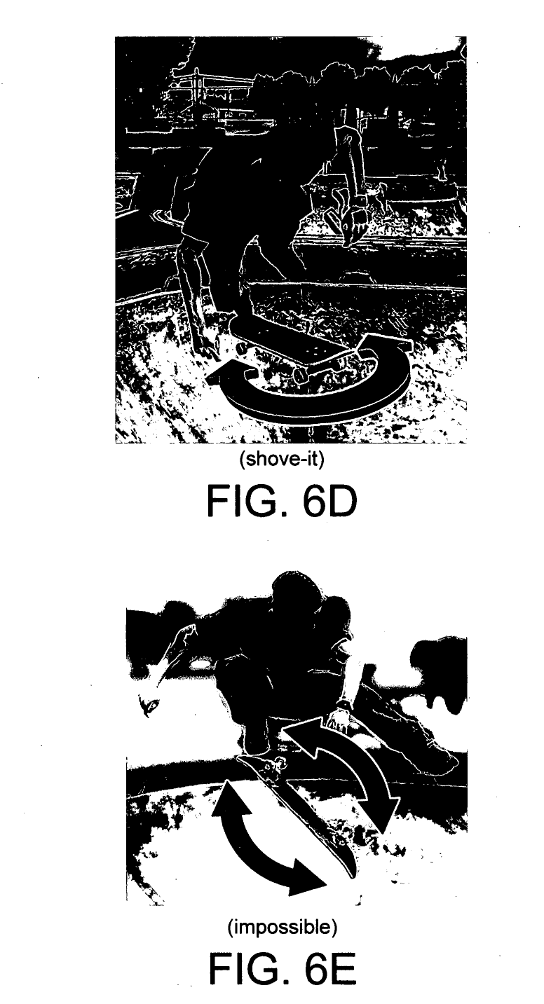

FIGS. 6A-6E together provide illustrate examples of use of multi-extremity control. FIGS. 6A-6E illustrate a representation of a display in which a character is a skateboarder, and an inanimate object is a skateboard. In FIG. 6A the skateboarder is standing on a skateboard, which is on the ground. Generally the skateboarder will be traveling along the ground, with the skateboard and a character moving through a simulated three-dimensional setting.

In FIG. 6B the skateboard and the skateboarder are airborne. A skateboard and skateboarder may be airborne by a variety of ways, such as by performing an ollie, by riding over a jump, by doing a vert off a ramp (notwithstanding that the skateboard and skateboarder are shown vertical to the ground), or through a number of other ways. In some embodiments an extremity control mode, such as a multi-axis multi-extremity control mode, is entered or enterable when the skateboarder is in the air.

FIG. 6C shows the skateboard performing a roll. A roll is performed, in some embodiments, referring generally to FIG. 5 for example, by moving the post 507 of the left controller 511 along the first axis 515. Movement of the post in what for convenience may be called a backwards movement may simulate, for example, a kick flip in which skateboarder moves a left foot backwards, brushing a toe against the heel side edge of the skateboard, and causing the skateboard to roll in a first direction. Conversely, a forward movement of the post may simulate a heel flip, whereby the skateboarder's left foot is moved forward, brushing a heel against the toe side edge of the skateboard, causing the skateboard to roll in an opposing direction. In many embodiments roll of the skateboard is provided when the left first input and the left second input indicate motion of the stick within a predefined angle of the first axis. In some embodiments roll of the skateboard is provided when the left first input indicates motion of the stick resulting in a sufficiently large component of motion along the first axis, in some embodiments roll velocity of the skateboard is dependent on angular position of the stick with respect to the first axis. In some embodiments roll velocity of the skateboard is dependent on magnitude of the left first input. In addition, in some embodiments changes in roll are only allowed if the skateboard position, or skateboard roll angle in some embodiments, is within a predefined range or ranges relative to the skateboarder.

FIG. 6D shows a skateboard yawing. Yaw of the skateboard may be induced for example by moving the post of the right extremity control along the first axis, either with a downward movement or an upward movement, simulating backward or forward movement of a skateboarder's right foot and leg, such as in a shove it maneuver. As with roll, in some embodiments changes in skateboard yaw are dependent on receiving an input of predefined magnitudes or inputs indicating stick movement or positioning within predefined angles. Similarly, as with roll, yaw velocity may be dependent on magnitude of the input or angular position of the stick. Moreover, in some embodiments changes in yaw are only allowed if the skateboard position, for example indicated by skateboard yaw angle, is within a predefined range relative to the skateboarder.

FIG. 6E shows the skateboard rotating in a pitch direction. Causing the skateboard to rotate in the pitch direction may be performed, for example, by moving the left control directly to the left (or the right control directly to the right), so as to perform an impossible maneuver, with the direction of pitch changes dependent on which control is used. For example use of the left control may result in pitch in one direction, and use of the right control may result in pitch in the opposing direction. In other embodiments, however, moving either the left control or the right control to the left results in pitch in one direction, and moving either the left control or the right control to the right results in pitch in the other direction. Again, in various embodiments obtaining changes in pitch or pitch velocity may be dependent on magnitude of inputs, stick angle as indicated by the inputs, and/or position of the skateboard relative to the skateboarder.

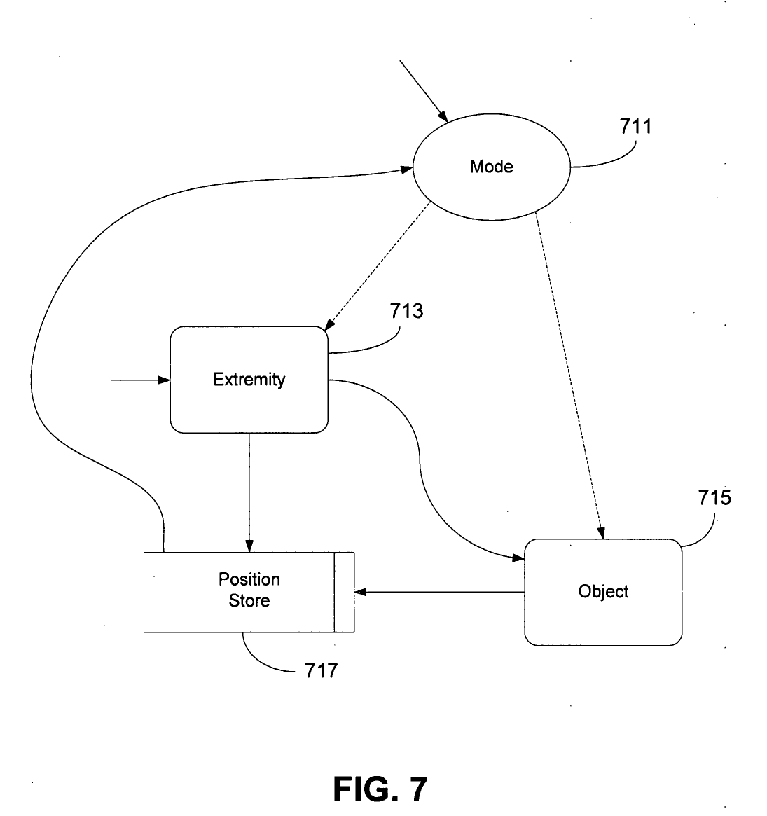

FIG. 7 is a module diagram of software programming in accordance with aspects of the invention. A mode control module 711 provides control information for an extremity module 713 and an object module 715. The mode module determines a mode of operation of extremities and objects with respect to control inputs. The extremity module determines movements and/or position of extremities. The position of extremities is provided to a position store 717, and also provided to the object module for processing by the object module. The object module determines movement and/or positioning of the object. The position of the object is also provided to the position store.

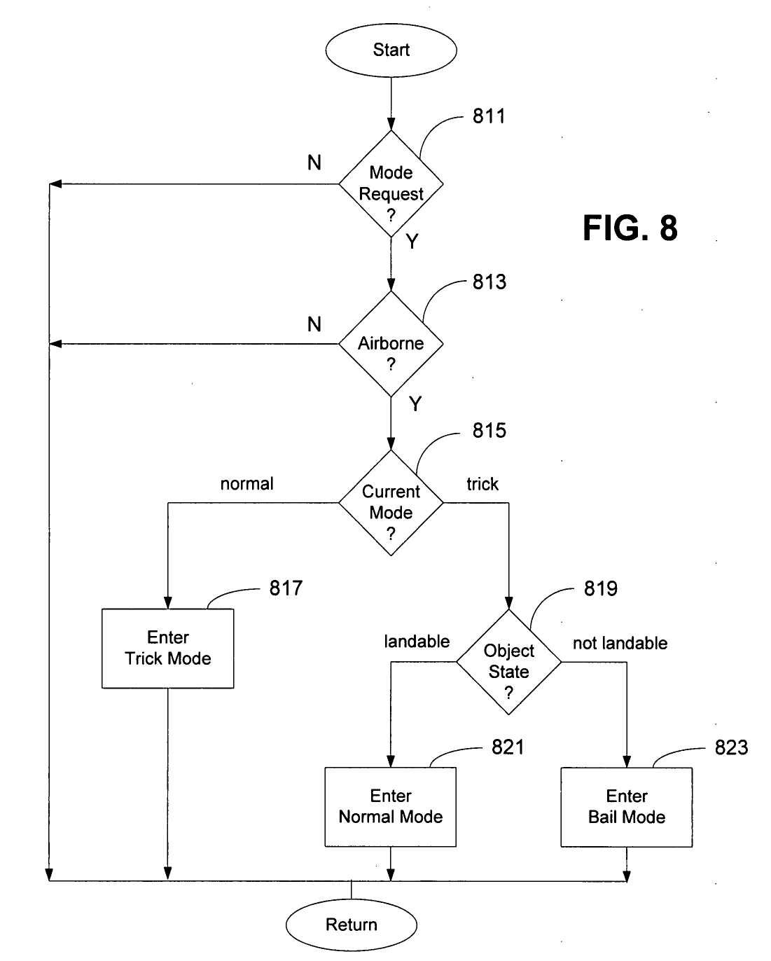

FIG. 8 is a flow diagram of a process for determining a mode of operation in accordance with aspects of the invention. In 811 the process determines if a mode request has been made. As shown in FIG. 8, the mode request may be a request to enter a trick mode or a request to exit a trick mode. In various embodiments, however, separate processing may be performed for each of entering a trick mode and exiting a trick mode. A mode request may be made by a user, for example, through depression of one or more game control buttons. In one embodiment, depression of a pushbutton which is part of a multi-axis control, or alternatively depression of two pushbuttons each part of different multi-axis control, results in an input signal or combined signals representative of a mode request. Further, in some embodiments release of the push-button or push buttons also results in an input signal or combined signals representative of a mode request. If no mode request has been made the process returns.

If the mode request has been made the process continues to block 813. In block 813 the process determines if an object, such as a skateboard, is airborne. If the object is not airborne the process returns. If the object is airborne, the process continues to block 815. In block 815 the process determines the current mode. If the current mode is a first mode, which may be referred to as a normal game play mode, the process enters trick mode in block 817. In some embodiments, in trick mode operation of analog controls, such as those described with respect to FIG. 5 for example, each allows for control of a corresponding skateboarder's leg or foot in multiple axes. Thus, in some embodiments, predetermined control inputs, such as multi-axis inputs, are mapped to control movement of a skateboard character's feet upon entering trick mode. In addition, in some embodiments slow motion of game play is also provided in trick mode. The process thereafter returns.

Returning to block 815, if the current mode is trick mode, the process determines the object's state in block 819. If the object state is not landable, then the process continues to block 823 and sets the mode to bail. The object is not landable, in some embodiments, if the object has a roll angle of greater than a predetermined range which, in one embodiment, would be plus or minus 10 degrees relative to the skateboarder or the skateboarder's extremities. For example, it is unrealistic, except for possibly the very talented, for the skateboard to be landed on its edge, or even upside-down for general skating operations, and an attempt to land the object in such a position is generally not feasible and the skateboarder will bail or crash. Similarly, in some embodiments all of roll, pitch, and yaw angles must be within predetermined limits for the object to be landable. In addition, in many embodiments the object is not landable if the object has been translated away from the skateboarder character, for example if the skateboard has been kicked away. If in block 819 the process determines the object is landable, namely that the skateboarder character can place his or her feet on the skateboard, land, and continue skating, the process continues to block 821 and enters the first mode, which may be a normal skating mode. The process thereafter returns.

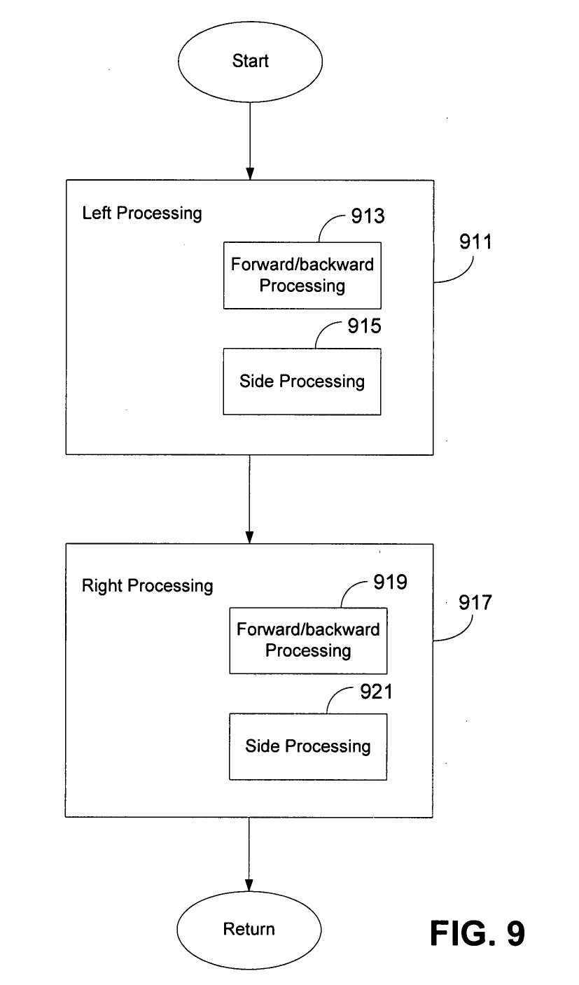

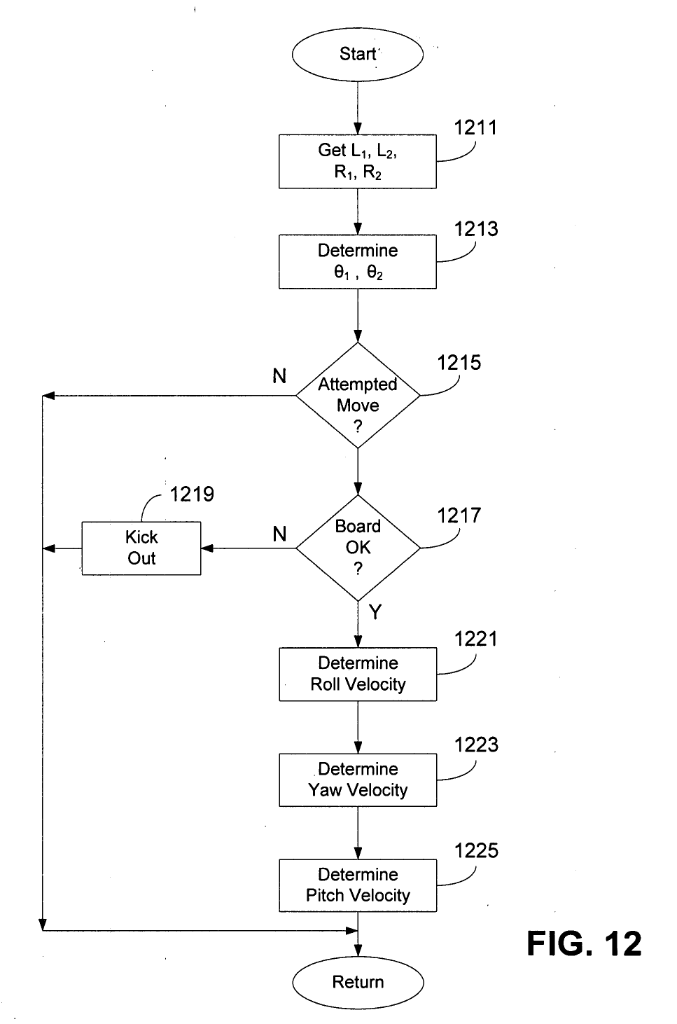

FIG. 9 is a flow diagram of a process for performing extremity control and for example trick mode. In block 911 the process performs left processing. Left processing generally includes forward/backward processing in block 913 and side processing in block 915. In block 917 the process performs right processing. Similar to left processing, right processing generally includes forward/backward processing 919 and side processing 921. In many embodiments, however, left processing and right processing, as well as forward/backward and side processing, are performed in a unified manner, for example as described with respect to the alternative embodiment of FIG. 12. The processing thereafter returns.

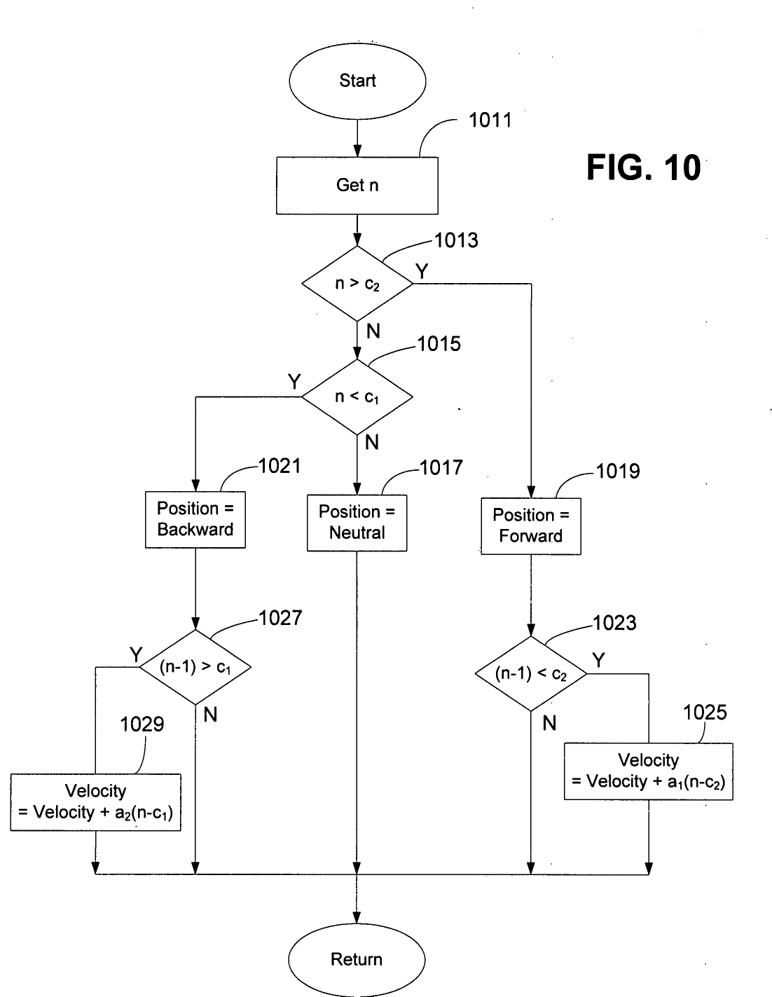

FIG. 10 is a flow diagram of an embodiment of a process for performing forward/backward processing, such as the forward/backward processing of FIG. 9. In block 1011 the process receives an input indicative of a control position. The control position may be a position of a control such as discussed with respect to FIG. 5. In block 1013 the process determines if the input is greater than a predefined value. Using the control of FIG. 5 as an example, the process determines if the moveable stick has a sufficiently large component of position along a first axis. If the input is greater than the predefined value the process continues to block 1019 and sets the position of the extremity to forward. In block 1023 the process determines if the prior value of the input was less than the predefined value. If the prior value of the input was less than the predefined value the process continues to block 1025 and modifies the current velocity to reflect an increase in velocity (or alternatively a decrease depending on positive and negative directions in a selected coordinate system). The velocity may be, for example, roll velocity for left forward/backward processing and yaw velocity for right forward/backward processing. In some embodiments, the velocity may be set equal to the current velocity plus the difference between the input and the predefined value, together multiplied by a constant. In other embodiments a look-up table may be used to determine velocities based on, for example, the value of the control input. In most embodiments the velocity is velocity for a particular direction.

In block 1013, if the process determines the input is less than the predefined value, the process continues to 1015.

In block 1015 the process determines if the input is less than a second predefined value. If the input is not less than the second predefined value, then the input is between the values of the first predefined value and the second predefined value, and the process continues to 1017 and sets the position of the extremity to a neutral position, with respect to forward/backward positioning. The process thereafter returns.

If, however, the value of the input is less than the second predefined value, the process sets the position of the extremity to backward in block 1021. In block 1027 the process determines if the extremity has just been moved to the backward position. This may be accomplished, for example, by comparing the prior value of the input to the second predefined value, with the prior value greater than the second predefined value indicating a change in position. If there has been a change in position the process decreases the velocity in a manner similar to that of block 1025. The process thereafter returns.

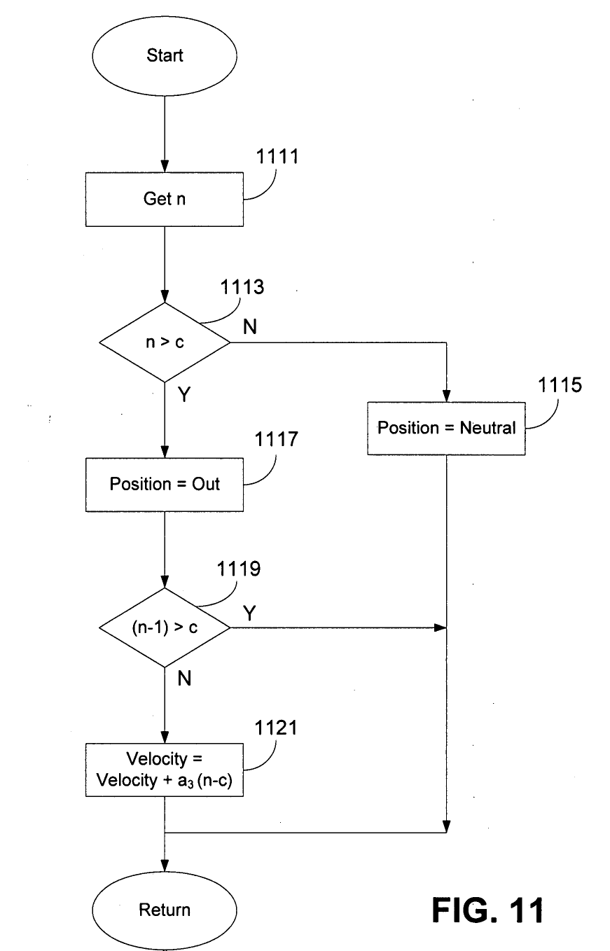

FIG. 11 is a flow diagram of an embodiment of a process for side processing, such as the side processing of FIG. 9, although in some embodiments a process such as that of FIG. 10 is used for side processing. In block 1111 the process receives an input indicative of a control position, for example the left control of FIG. 5. In block 1113 the process determines if the input is greater than a predefined value, although it should be recognized that depending on which input is used and/or direction of increasing values for the input that a less than determination may be made. If the input is not greater than the predefined value then the process sets the extremity to a neutral position, with respect to side-to-side positioning.

If the input is greater than the predefined value, the process continues to block 1117 and sets the extremity to an out position, without for example being away from the body in a sideways direction. In block 1119 the process determines if the prior value of the input was less than the predefined value. If so, the process returns. Otherwise the process sets the velocity, for example the pitch velocity, of the inanimate object to the prior velocity plus an amount dependent on the magnitude of the input. The process thereafter returns.

If the input is not greater than the predefined value, the process continues to block 1115 and sets the extremity to a neutral position. The process thereafter returns.

FIG. 12 is a flow diagram of an embodiment of a process for processing inputs and determining skateboard position related information in a unified manner. In block 1211 the process receives input information from a left control, for example the left control 511 of FIG. 5, and a right control, for example the right control 513 of FIG. 5, with each of the left control and the right control providing a first input (L₁, R₁) and a second input (L₂, R₂). For example, the inputs are provided by a control such as that described with respect to FIG. 5, in which inputs indicative of position of a stick in two axes is provided, with a first input indicating position in a first axis and a second input indicating position in a second axis.

In block 1213 the process determines an angle (θ₁) of position of the stick of the left control and an angle (θ₂) of position of the stick of the right control. For example, if forward motion of the stick in the embodiment of FIG. 5 is along the first axis, forward motion along the first axis may be considered to have an angle of zero degrees, with angles increasing in a counter-clockwise fashion. The angle may be determined mathematically in a number of ways, such as for example calculating the inverse tangent of offsets from the center position along the two axes, through use of a look-up table, or other methods.

In block 1215 the process determines if a move was attempted. In some embodiments a move is attempted if the inputs have been moved away from the center position. If no move has been attempted the process returns. If a move has been attempted, the process, in block 1217, determines if the skateboard is in an appropriate position for a move. In many embodiments, position is appropriate for a move if the current roll, pitch, yaw angles of the skateboard are within a predefined range. If the skateboard is not in an appropriate position, the process kicks-out the board in block 1219. Generally, if a skateboard is not in an appropriate position for performance of further rotations or tricks at a time when a trick is attempted, the board will be kicked away from the skateboarder, for example the skateboard will move by way of translation away from the skateboarder. Generally after a kick-out, the skateboarder will bail or crash, with the skateboard landing at some distance away from the skateboarder.

If the board is in the appropriate position for a move, in block 1221 the process determines roll velocity for the board. In some embodiments a roll velocity is imparted into the skateboard if the left input is positioned within a predefined angle of the first axis of the controller. For example, in some embodiments the skateboard is imparted a roll velocity if movement of the stick of the left controller is within 10 degrees of the first axis, indicative of movement of the left skateboarder's foot to perform either a heel flip or a kick flip.

In some embodiments, and as previously discussed, each move may impart additional velocity or different velocities to the skateboard. In other embodiments, however, each move independently determines velocity of the skateboard, in effect resetting the velocity of the skateboard upon the occurrence of each move. Further, in some embodiments the velocity imparted to the skateboard is a function of the angle of the stick. In some embodiments the velocity may be some mathematical function in terms of cos (θ₁), with the sign of the cosine function indicating direction of roll. In other embodiments, roll velocity may be based on use of a look-up table, with the look-up table providing different velocities for varying angles.

In block 1223 the process determines yaw velocity. In some embodiments yaw of the skateboard, which may occur during a shove-it maneuver, is performed by movement of the right stick in an up or down manner. Accordingly, yaw of the skateboard is controlled using the right stick in a manner similar to roll control performed using the left stick.

In block 1225 the process determines pitch velocity of the skateboard. In most embodiments, pitch of the skateboard is controlled using either the left or right stick. Accordingly, in determining pitch velocity the process determines whether either the angle θ₁ or the angle θ₂ is within a predefined angle of 90 degrees or 270 degrees, with again pitch velocity dependent on angle of the stick. the process thereafter returns.

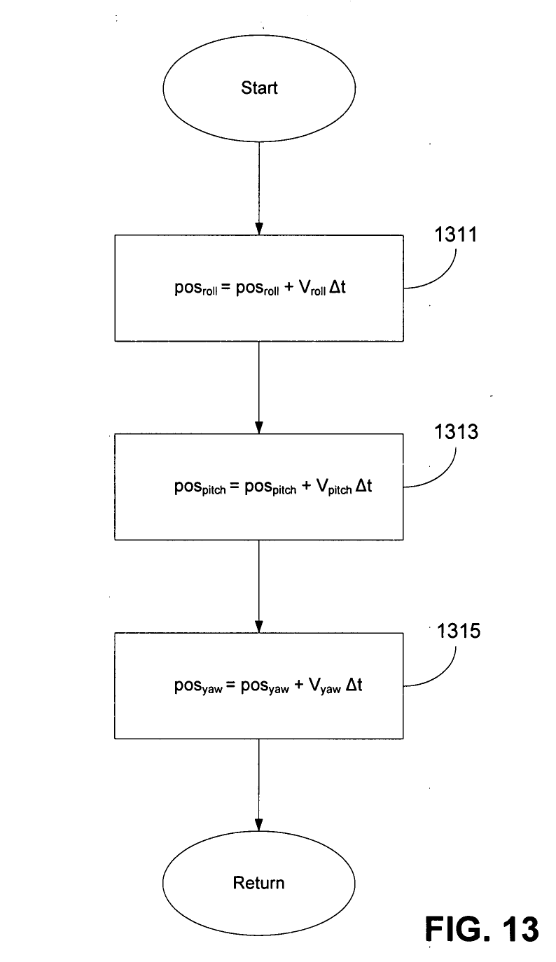

FIG. 13 is a flow diagram of a process for determining position of an inanimate object, for example a skateboard. In block 1311 the process determines a roll position of the object. As illustrated in FIG. 13, the roll position is set to the current roll position plus roll velocity (which may be either positive or negative) multiplied by a time difference, such as a difference in simulated time between a current simulated time and a prior simulated time at which roll position was calculated. In block 1313 pitch position is determined, for example by adding pitch velocity multiplied by the time difference to a current pitch position. In block 1315 yaw position is determined, for example by adding yaw velocity multiplied by the time difference to a current yaw position.

In various embodiments other equations may be used to determine roll, pitch, and yaw positions, such as equations including acceleration terms, inertial moments, and/or friction terms. In some embodiments, particularly embodiments in which only a finite number of roll, pitch, or yaw positions are used, look up tables may be employed, with an index to the lookup table modified in view of velocity, for example, with difference in time set or assumed to be constant.

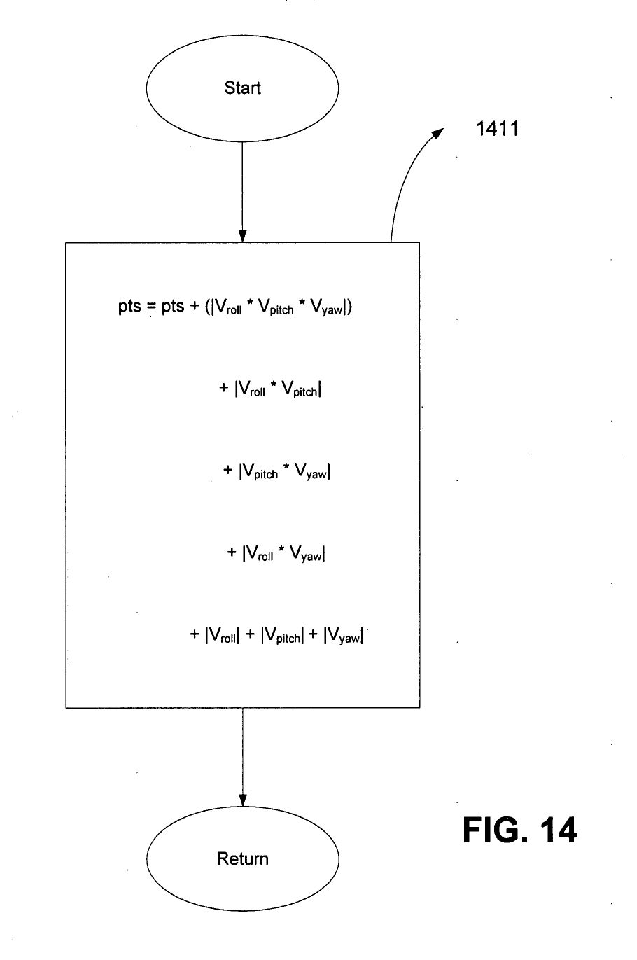

FIG. 14 is a flow diagram of a process for determining points based on movement of the inanimate object. Considering again the skateboarder of FIG. 6, different moves may be considered to be of greater or lesser difficulty, with different points provided, such as by way of adding to a cumulative point score or by way of point categories of special meaning. For example, a shove-it may be considered a move worthy of a predetermined number of points, and a kick flip may be considered a move worthy of a greater number of points. Moreover, combinations of moves may be considered of even greater difficulty than each move of the combination considered separately.

In the embodiment of FIG. 14, the process determines in block 1411 a cumulative point score. The cumulative point score is set equal to a current point score plus a sum of terms, seven terms in FIG. 14, related to velocity of the inanimate object, for example a skateboard. Three of the terms are absolute values of velocity in each of a pitch, roll, and yaw directions. Three of the terms are absolute values of velocity in one direction multiplied by velocity in another direction, such that all combinations of two of pitch, roll, and yaw are considered. One of the terms is the absolute value of roll velocity multiplied by pitch velocity multiplied by yaw velocity. In various embodiments only some of the terms may be used, different coefficients for each of the terms may be used, or different point scoring schemes may be used.

For example, in some embodiments points are based on movement of the inanimate object, for example rotation of the inanimate object. Thus, for example, in an embodiment points may be added to a cumulative point score for every complete rotation of the inanimate object about an axis. Moreover, the number of additional points provided by each rotation may be increased, for example by use of a points multiplier, for rotations in a new direction, for “truck side up” moves, for each additional new move, or for other criteria. In addition, in embodiments allowing for rotation of the character, additional points may be provided for rotation of the character.

Accordingly, the invention provides for multi-axis and multi-extremity control in a video game. Although the invention has been described with respect to certain embodiments, it should be recognized that the invention may be practiced other than as specifically discussed, and the invention comprises the claims and their insubstantial variations supported by this disclosure.

What is claimed is:

1. A method of providing an aerial trick mode in a skateboarding video game, the skateboarding video game comprising computer executable code executing on a processor providing a simulated skateboarding experience, the method comprising:
mapping movement control of a first extremity of a skateboarder character to a first multi-axis input and mapping movement control of a second extremity of the skateboarder character to a second multi-axis input;
moving the first extremity of the skateboarder character based on the first multi-axis input and moving the second extremity of the skateboarder character based on the second multi-axis input;
moving an inanimate object associated with the skateboarder character based at least in part on the first multi-axis input and the second multi-axis input.

2. The method of claim 1 further comprising slowing down a simulated passage of time.

3. The method of claim 1 wherein the inanimate object is a skateboard.

4. The method of claim 1 wherein the first extremity is a first leg of the skateboarder character and the second extremity is a second leg of the skateboarder character.

5. The method of claim 3 wherein moving the skateboard associated with the skateboarder character based at least in part on the first multi-axis input and the second multi-axis input comprises rotating the skateboard associated with the skateboarder character based at least in part on the first multi-axis input and the second multi-axis input.

6. The method of claim 5 wherein the skateboard is rotatable about three axes.

7. The method of claim 6 wherein the first multi-axis input provides for rotation about a first axis of the three axes and the second multi-axis input provides for rotation about a second axis of the three axes.

8. The method of claim 7 wherein both the first multi-axis input and the second multi-axis input provides for rotation about a third axis of the three axes.

9. The method of claim 8 wherein rotating the skateboard in the first axis changes roll of the skateboard, rotating the skateboard in the second axis changes yaw of the skateboard, and rotating the skateboard in the third axis changes pitch of the skateboard.

10. The method of claim 3 wherein moving the skateboard associated with the skateboarder character based at least in part on the first multi-axis input and the second multi-axis input comprises moving the skateboard associated with the skateboarder character based at least in part on the first multi-axis input and the second multi-axis input and the position of the skateboard with respect to the skateboarder character.

11. The method of claim 10 wherein moving the skateboard associated with the skateboarder character based at least in part on the first multi-axis input and the second multi-axis input and the position of the skateboard with respect to the skateboarder character comprises rotating the skateboard associated with the skateboarder character based on the first multi-axis input and the second multi-axis input if the skateboard is within a predefined range of positions with respect to the skateboarder character and comprises translating position of the skateboard with respect to the skateboarder character based on the first multi-axis input and the second multi-axis input if the skateboard is not within the predefined range of positions with respect to the skateboarder character.

12. The method of claim 3 further comprising maintaining a point score associated with the skateboarder character and providing for additional points based on rotation of the skateboard.

13. The method of claim 1 wherein moving the first extremity of the skateboarder character based on the first multi-axis input and moving the second extremity of the skateboarder character based on the second multi-axis input comprises moving the first extremity of the skateboarder character to mirror movement of the first multi-axis input and moving the second extremity of the skateboarder character to mirror movement of the second multi-axis input.

14. The method of claim 3 wherein moving the skateboard associated with the skateboarder character based at least in part on the first multi-axis input and the second multi-axis input comprises imparting a rotational velocity to the skateboard dependent on a direction of movement of the either the first multi-axis input or the second multi-axis input.

15. The method of claim 14 wherein magnitude of the rotational velocity is dependent on degree of closeness of the direction of movement to a predefined direction.

16. A method of providing trick operations in a skate boarding video game, comprising:
modifying a simulated rate of passage of time in response to a valid request to enter a trick mode;
simulating movement of a simulated extremity along a first axis in response to a request to move the simulated extremity along the first axis; and
simulating three dimensional movement of a simulated skateboard in accordance with the simulated movement of the simulated extremity.

17. The method of claim 16 wherein the valid request to enter the trick mode comprises a request to enter the trick mode when the simulated skateboard is airborne.

18. The method of claim 16 further comprising simulating movement of the simulated extremity along a second axis in response to a request to move the simulated extremity along the second axis.

19. The method of claim 18 further comprising simulating movement of another simulated extremity along the first axis in response to a request to move the other simulated extremity along the first axis and simulating movement of the other simulated extremity along the second axis in response to a request to move the other simulated extremity along the second axis.

20. The method of claim 19 further comprising simulating three dimensional movement of the simulated skateboard in accordance with the simulated movement of the other simulated extremity.

21. The method of claim 20 wherein three dimensional movement of the simulated skateboard along pitch, roll, and yaw axes of the simulated skateboard.

22. The method of claim 21 wherein simulated three dimensional movement of the simulated skateboard is along a first axis of the pitch, roll, and yaw axes for simulated movement of the extremity along the first axis of the pitch, roll, and yaw axes and simulated three dimensional movement of the simulated skateboard is along a second axis of the pitch, roll, and yaw axes for simulated movement of the other extremity along the first axis.

23. The method of claim 22 wherein the first axis of the pitch, roll, and yaw axes is different than the second axis of the pitch, roll, and yaw axes.

24. The method of claim 22 further comprising providing a point score, the point score related to simulated motion of the simulated skateboard.

25. The method of claim 24 wherein simulated three dimensional movement of the simulated skateboard has a variable velocity along at least one of the pitch, roll, and yaw axes.

26. The method of claim 25 wherein the variable velocity is dependent on a magnitude of request for simulated movement of the extremity or a magnitude of request for simulated movement of the other extremity.

27. The method of claim 25 wherein the variable velocity is dependent on angle of direction of request to move the simulated extremity.

28. The method of claim 21 wherein the simulated skateboard has a grip tape side, a truck side, and side walls connecting the grip tape side and the truck side, and simulated motion of the simulated skateboard is not affected by simulated movement of the extremity or simulated movement of the other extremity if the grip tape side or the truck side are not simulated as within a predefined range of facing the simulated extremity or the simulated other extremity.

29. The method of claim 28 wherein modifying the simulated rate of passage of time in response to the valid request to enter the trick mode comprises slowing down the simulated rate of passage of time.

30. The method of claim 29 further comprising speeding up the simulated rate of passage of time in response to a valid request to exit the trick mode.

31. The method of claim 30 wherein the valid request to exit the trick mode comprises a request to exit the trick mode when the grip tape side is simulated as within a predefined range of facing the simulated extremity or the simulated other extremity.

32. A video game system including an extremity control feature, comprising:
a memory storing executable video game code including executable code providing at least partial control of a representation of an individual interacting with a representation of an inanimate object in a simulated setting, the partial control including independent simulated movement of each of two extremities in at least two axes of motion, with movement of each extremity in at least one axis of motion resulting in modification of simulated motion of the representation of the inanimate object; and
a processor in data communication with the memory, the processor configured to execute the executable video game code, to receive signals indicative of commands for simulated movement of each of the two extremities, to modify data representative of the position of each of the two extremities, and to modify data representative of simulated motion of the representation of the inanimate object.

33. The video game system of claim 32, wherein the simulated motion of the representation of the inanimate object comprises simulated motion in the pitch, roll, and yaw directions.

34. The video game system of claim 32 wherein the executable video game code further includes executable code providing a point score, the point score based in part on the data representative of simulated motion of the representation of the inanimate object.

35. The video game system of claim 32 wherein the executable code providing at least partial control of a representation of an individual interacting with a representation of an inanimate object in a simulated setting, the partial control including independent simulated movement of each of two extremities in at least two axes of motion, with movement of each extremity in at least one axis of motion resulting in modification of simulated motion of the representation of the inanimate object, provides modification of simulated motion of the representation of the inanimate object along different axes for simulated movement of different extremities in a same axis of motion.

36. A method of providing extremity control in a video game executed by a processor, comprising:
providing for a first rate of passing of video game time;
associating a first input with a first predefined video game response;
receiving a signal indicative of a request to provide for control of an extremity and provide for a reduction in the rate of passing of video game time;
reducing the rate of passage of video game time; and
associating the first input with a second predefined video game response, the second predefined video game response comprising control over movement of an extremity of a video game character, with movement of a control associated with the first input resulting in a corresponding movement of the extremity for at least some directions of movement of the control.

37. A method of controlling movement of a skateboard in a video game, comprising:
determining whether a skateboard is airborne;
receiving a first request indicative of a command to rotate the skateboard in a first direction;
rotating the skateboard in a first direction in response to the first request if the skateboard is airborne;
receiving a second request indicative of a command to rotate the skateboard in a second direction; and
rotating the skateboard in the second direction in response to the second request if the skateboard is airborne.

38. The method of claim 37 wherein the first request indicative of the command to rotate the skateboard in the first direction is a request to move a first extremity of a skateboarder character associated with the skateboard in a third direction.

39. The method of claim 38 wherein the second request indicative of the command to rotate the skateboard in the second direction is a request to move a second extremity of the skateboarder character associated with the skateboard in a fourth direction.

40. The method of claim 39 wherein the first extremity and the second extremity are the same extremity.

41. The method of claim 39 wherein the first extremity and the second extremity are different extremities.

42. The method of claim 37 wherein rotating the skateboard in the second direction in response to the second request if the skateboard is airborne further requires that the skateboard be in a predefined range of positions with respect to a skateboarder character associated with the skateboard.

43. A video game system providing a skateboarding game, comprising:
a first multi-axis input device;
a second multi-axis input device;
a processor configured to move a first extremity of a skateboarder character to an input generated responsive to the first multi-axis input device and configured to move a second extremity of the skateboarder character to an input generated responsive to the second multi-axis input device, with direction of movement of the first extremity having a correspondence to direction of movement of the first multi-axis input device and direction of movement of the second extremity having a correspondence to direction of movement of the second multi-axis input device.

44. The video game system of claim 43 wherein the processor is further configured to move a skateboard associated with the skateboarder character based on movement of the extremities.
